(19) United States
(12) Patent Application Publication
(10) Pub. No.: US 2010/0147114 A1
(43) Pub. Date: Jun. 17, 2010

(54) BEVERAGE CONTAINER WITH BOTTLE OPENER

(76) Inventor: Prasad Peddada, Alameda, CA (US)

Correspondence Address: FLIESLER MEYER LLP, 650 CALIFORNIA STREET, 14TH FLOOR, SAN FRANCISCO, CA, 94108, US

(21) Appl. No.: 12/632,533

(22) Filed: Dec. 7, 2009

Related U.S. Application Data
(60) Provisional application No. 61/122,324, filed on Dec. 12, 2008.

(51) Int. Cl. B67B 7/44

(52) U.S. Cl. 81/3.15

(57) ABSTRACT

In accordance with an embodiment, a beverage container is provided which includes an external indication that the beverage container includes a bottle opener or other food opener inside. Such external indication can be in the form of words, or a pictorial or symbolic representation of a bottle opener. When the consumer purchases the container of beverages, they can open the container to remove the bottle opener, and then use the bottle opener to open the individual bottles. This eliminates the need to purchase separately or find a previously-owned bottle opener, and can encourage sales of certain bottled beverages over others that do not include their own bottle opener.

### CLAIM OF PRIORITY

This applicant claims the benefit of priority to U.S. Provisional Patent Application Ser. No. 61/122,324, titled “BEVERAGE CONTAINER WITH BOTTLE OPENER”, filed Dec. 12, 2008, and herein incorporated by reference.

### FIELD OF INVENTION

The invention is generally related to beverage containers, and means for distributing bottle openers, or other beverage or food openers.

### BACKGROUND

Beverages, such as beer, wine, soda, and other alcohol and non-alcohol drinks, are generally distributed in bulk purchase containers that contain within a number, commonly 6 to 24 individual bottles of the beverage. However, once the consumer has made their purchase, they must often purchase separately or find a previously-owned bottle opener to then open the bottles. This is the general area that embodiments of the invention are designed to address.

### SUMMARY

Described herein is a beverage container, and means for distributing bottle openers. In accordance with an embodiment, a beverage container is provided which includes an external indication that the beverage container includes a bottle opener or other food opener inside. Such external indication can be in the form of words, or a pictorial or symbolic representation of a bottle opener. When the consumer purchases the container of beverages, they can open the container to remove the bottle opener, and then use the bottle opener to open the individual bottles. This eliminates the need to purchase separately or find a previously-owned bottle opener, and can encourage sales of certain bottled beverages over others that do not include their own bottle opener.

### BRIEF DESCRIPTION OF THE DRAWINGS

FIG. 1 shows a beverage container with pictorial or symbolic representation of a bottle opener, in accordance with an embodiment.

FIG. 2 shows an alternative beverage container with pictorial or symbolic representation of a bottle opener, in accordance with an embodiment.

FIG. 3 shows a bottle removed from the beverage container, with its included bottle opener, in accordance with an embodiment.

FIG. 4 shows how the bottle opener can be retrieved and used with a bottle, in accordance with an embodiment.

### DETAILED DESCRIPTION:

Described herein is a fastener, connector, and/or in accordance with an embodiment, a beverage container is provided which includes an external indication that the beverage container includes a bottle opener inside.

Such external indication can be in the form of words, or a pictorial or symbolic representation of a bottle opener. When the consumer purchases the container of beverages, they can open the container to remove the bottle opener, and then use the bottle opener to open the individual bottles. This eliminates the need to purchase separately or find a previously-owned bottle opener, and can encourage sales of certain bottled beverages over others that do not include their own bottle opener.

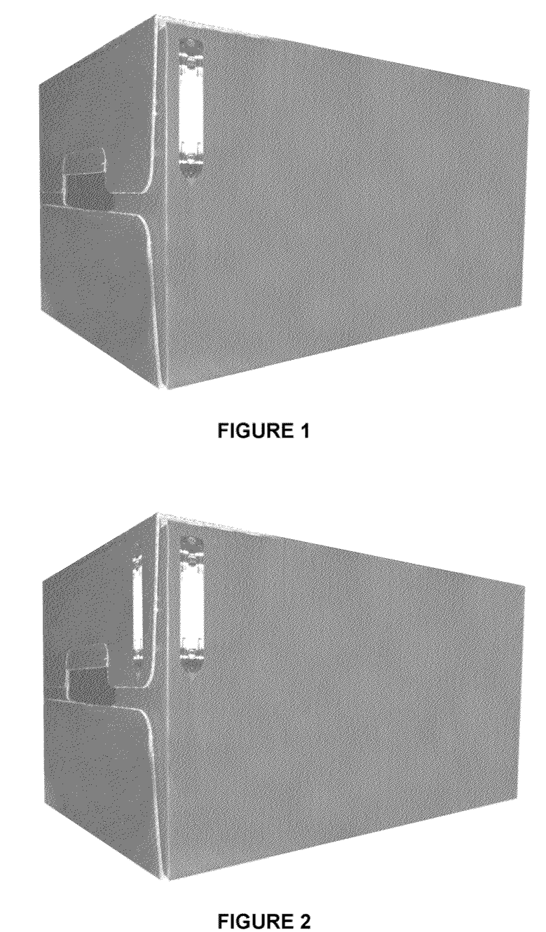

FIG. 1 shows a beverage container with pictorial or symbolic representation of a bottle opener, in accordance with an embodiment. As shown in FIG. 1, in accordance with an embodiment, the container can include an external indication in the form of text, words, or in this example a pictorial representation of a bottle opener. This indicates to the consumer that the container includes a bottle opener for use with the bottles therein. In accordance with an embodiment, the external indication can also indicate to the consumer precisely where the bottle opener is located within the container, e.g. in which corner, so that the container can be opened at that corner to retrieve the bottle opener.

FIG. 2 shows an alternative beverage container with pictorial or symbolic representation of a bottle opener, in accordance with an embodiment. As shown in FIG. 2, the external indication, in this example a pictorial representation of a bottle opener, can be provided on two or more sides of the beverage container, for greater ease of identification when the container is stacked in a retail store.

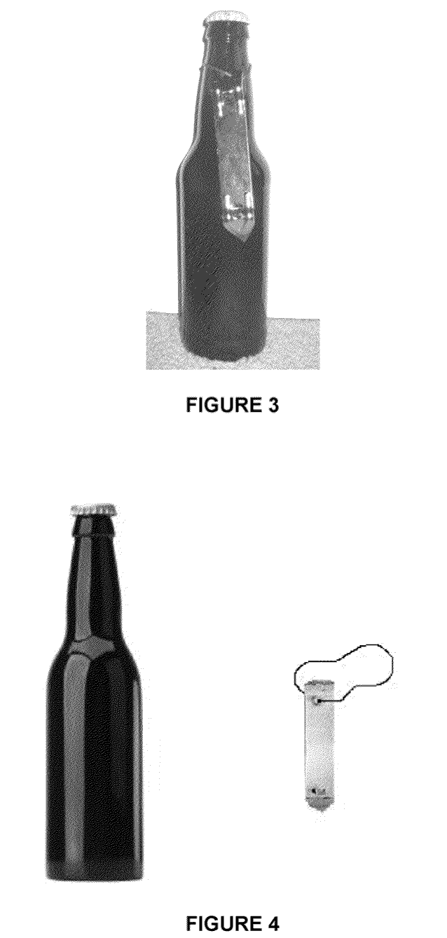

FIG. 3 shows a bottle removed from the beverage container, with its included bottle opener, in accordance with an embodiment. As shown in FIG. 3, in accordance with an embodiment the bottle opener, or another type of opener, can be hung around one of the bottles within the container using a string, chain, or similar means. Although the bottle opener shown in FIG. 3 is a plain design, in accordance with other embodiments other designs of bottle opener, including those that include branding, advertising, promotional information, or in novelty shapes, can be provided. In alternative embodiments, the bottle opener can be affixed to one of the bottles inside the container, or to the beverage container itself. If the latter, then the bottle opener can be affixed either to the inside, or on the outside of the beverage container.

FIG. 4 shows how the bottle opener can be retrieved and used with a bottle, in accordance with an embodiment. As shown in FIG. 4, the consumer can simply remove the bottle opener and use it with the bottles in the container. When finished, the consumer can keep the bottle opener for future use, or can recycle it if desired.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A beverage container, and means for distributing bottle openers, or other beverage or food openers, comprising:
a container for holding bottles, wherein the container includes a housing;
a plurality of bottles within the container; and
a bottle opener disposed within the container, wherein the bottle opener can be extracted and used to open one or the plurality of bottles.

2. The beverage container of claim 1, wherein the bottle opener is affixed to the inside of the housing of the container.

3. The beverage container of claim 1, wherein the bottle opener is affixed to the outside of the housing of the container.

4. The beverage container of claim 1, wherein the bottle opener is affixed to or suspended from one of the bottles within the container.

5. The beverage container of claim 1, wherein the bottle opener is generally provided within the container.

6. The beverage container of claim 1, wherein the housing includes on its external surface an indication that the container also includes a bottle opener, such as a textual, picture or other pictorial or symbolic representation of a bottle opener on the external surface of the container.

7. A means of distributing beverages, comprising:
providing a container for holding bottles;
providing a plurality of bottles within the container; and
providing a bottle opener disposed within the container, which can be extracted and use to open one or the plurality of bottles.
